(19) United States
(12) Patent Application Publication
(10) Pub. No.: US 2014/0094187 A1
(43) Pub. Date: Apr. 3, 2014

(54) LOCATION ESTIMATION BASED UPON AMBIENT IDENTIFIABLE WIRELESS SIGNAL SOURCES

(71) Applicants: Anthony G. LaMarca, Seattle, WA (US); Jaroslaw J. Sydir, San Jose, CA (US)

(72) Inventors: Anthony G. LaMarca, Seattle, WA (US); Jaroslaw J. Sydir, San Jose, CA (US)

(21) Appl. No.: 13/630,756

(22) Filed: Sep. 28, 2012

(51) Int. Cl. H04W 24/00

(52) U.S. Cl. 455/456.1

(57) ABSTRACT

Described herein are technologies related to estimating location of a mobile device especially while the device is traveling a known and mapped route. That is, the described technologies estimate a user's location when they are traversing a commonly traveled route. More particularly, the described technologies are especially suited to estimating geo-location of a user. This Abstract is submitted with the understanding that it will not be used to interpret or limit the scope or meaning of the claims.

### BACKGROUND

The use of mobile devices, such smartphones, is nearly ubiquitous. Many of these mobile devices include the capability to determine their physical location. That is, the mobile device is capable of determining its location in the physical world. Conventionally, location determination is typically accomplished by using Global Positioning Systems (GPS), some form of triangulation or interpolation of multiple radio signals, internet protocol (IP) geo-location, or some combination thereof.

A collection of so-called location-based services (LBS) are emerging that take advantage of the location-detection capability of the mobile devices that so many are carrying with them each day. For example, LBS include targeted advertising, social networking, locating friends (“check-ins”), photo-tagging, life logging, location-based games, fitness monitoring, etc. LBS may include vehicle or parcel tracking as well.

Using the location-detection capability of mobile devices, some LBS may offer destination or estimated-time-of-arrival (ETA) prediction. Such predictions may be useful to avoid congestion, identify convenient and interesting waypoints (e.g., a gas station, coffee shop, etc.), and the like. GPS technology is the most common technology utilized for ETA prediction.

### BRIEF DESCRIPTION OF THE DRAWINGS

FIG. 1 illustrates a process in accordance with one or more implementations described herein.

FIG. 2 shows an example neighborhood map that is used to illustrate implementations in accordance with the description herein.

FIG. 3 shows an example route graph that is used to illustrate implementations in accordance with the description herein.

FIG. 4 illustrates an example route traversal in accordance with one or more implementations described herein.

FIG. 5 illustrates an example route traversal in accordance with one or more implementations described herein.

FIG. 6 illustrates an example system in accordance with one or more implementations described herein.

FIG. 7 illustrates an example computing device to implement in accordance with the technologies described herein.

FIG. 8 illustrates an example device to implement in accordance with the technologies described herein.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Disclosed herein are technologies for estimating location of a mobile device especially while the device is traveling a known and mapped route. That is, the described technologies estimate a user's location when they are traversing a commonly traveled route. More particularly, the described technologies are especially suited to estimating geo-location of a user.

Geo-location may also be called geo-physical location. It includes determination of a real-world geographic location of an object or person. A location may also be called physical location. It is a broader term than geo-location. Location includes a determination of any real-world location of the object or person. Geo-location encompasses the outdoors and perhaps part of the indoors. Location encompasses both the outdoors and indoors.

Conventional location-determination approaches include global positioning systems (GPS) and signal positioning (e.g., triangulation, trilateration and other forms of interpolation and extrapolation) to determine geophysical location relative to multiple signal sources. GPS is near-ubiquitous outdoor location technology and a typical smartphone has 3-5 meter accuracy. For signal positioning, the signal sources may use cellular or a variant of IEEE 802.11 (i.e., WiFi). Signal-positioning approaches rely upon a map of signal sources, whose location is known, to extrapolate a location of a device. Compared to conventional approaches to location determination, the technologies described herein do not need a network connection to estimate location, location estimation is near the accuracy of GPS (e.g., 3-5 meters), and consume far less power (e.g., about ten times less) than the conventional approaches.

It may seem that a location estimation may have limited desirability for a person when she is travelling common trip. After all, those are precisely the times when a person is likely to know where they are and not in need for navigation assistance. However, increasingly, location information is being used by background applications and services of a mobile device and not directly by the user of the device. Such services include geofencing systems, digital pedometers, food loggers, eldercare monitors, carbon-footprint trackers, ETA estimation, social networking, targeted advertising, car insurance based on driving behavior, etc.

Such services and applications make continuous use of location information and provide the user with higher-level information inferred from, among other things, location. In addition, these services run all the time, even when the user knows where they are. These location-based services and applications encourage the mobile device to have an always-on location capability. Unfortunately, conventional location determination options (e.g., GPS and signal triangulation) quickly drain the limited power resources of the mobile device. However, with the technology described herein, a mobile device can accurately estimate its location while minimizing power consumption.

Using the technology described herein, a mobile device may learn a place and a route using existing or new approaches for doing so. While traveling a learned or otherwise known route, the mobile device maps the route by correlating WiFi fingerprinting and location determinations (especially geo-location determinations). Such location determinations are acquired by, for example, using GPS, signal positioning, or other existing or new approaches for doing so. When mobile device journeys along the known and mapped route, the device estimates its location based upon ambient identifiable wireless signal (IWS) sources encountered on that route.

The ambient IWS sources are part of a topography of such IWS sources that are located within reception range along a route being traveled or have been previously detected along a route that was traveled. An example of an IWS sources is a wireless access point (WAP), which allows access to a wired network using Wi-Fi, Bluetooth, or other such wireless communication standards.

However, the conventional GPS technology is resource intensive. In particular, GPS technology is computationally demanding and power hungry. Most users have learned to use their GPS sparingly when their mobile device is battery dependent. Otherwise, the GPS quickly drains the battery of their mobile device. Such behavior is fine, if inconvenient, for location services that make sporadic use of geolocation. However, for the new, always-on applications and services mentioned, this is unacceptable.

### WiFi Fingerprinting

One or more implementations of the technologies described herein utilize a WiFi-based positioning approach, which is often called “WiFi fingerprinting.” Such systems are commonly used indoors where GPS fails to operate. Generally, WiFi fingerprinting involves memorizing the WAP “fingerprint” of “visible” WAP and the observed signal strengths for a location.

Conventionally, WiFi fingerprinting requires a detailed survey of the radio landscape in which the WAP identifications and observed signal-strengths are collected in a dense grid by sampling throughout the localization area. Each fingerprint is associated with the location at which it was observed. Once an area has had its fingerprint map (i.e., database) created, a typical mobile devices can perform a WiFi scan, perform a database lookup and estimate their location within that area with a typical accuracy of 1-3 meters. WiFi fingerprinting techniques are low power, accurate and work with any WiFi-enabled device.

However, construction of a conventional WiFi fingerprint map is time consuming and requires tens of fingerprints to be collected every square meter for optimal performance. Constructed in this conventional way, the WiFi fingerprint map is only useful for the area in which it was collected and interpolation in not possible for more than a few meters beyond the map. As a result, conventional WiFi fingerprinting is a good solution for houses and small buildings, difficult to deploy at a campus scale, and impossible to deploy over a city or larger area.

### Example Process of Location Estimation

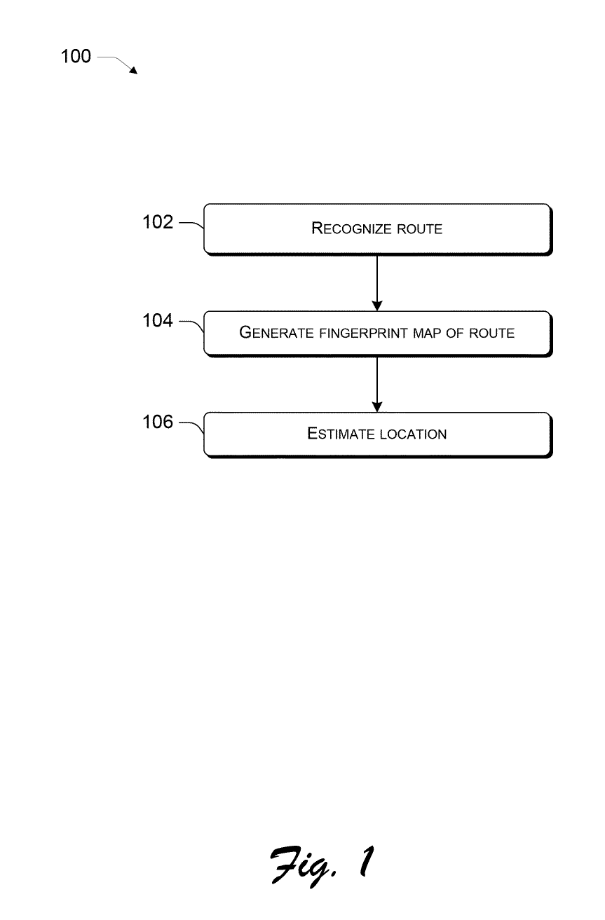

FIG. 1 shows the overall three phases, stages, or operations of an example process 100 for implementing, at least in part, the technology described herein. The example process 100 may be performed by a single wireless device. Alternatively, differing devices that presumably work in a cooperative manner may perform each operation of the process 100.

The example process 100 includes the following operations, stages, or phases:
Recognize route at 102;
Generate fingerprint map of route at 104; and
Estimating a present location or geo-location based upon the previously mapped routes at 106.

As part of each of these operations, a wireless device may encounter an ambient IWS source while that wireless device is traveling. The encounter includes: detecting the ambient IWS source while traversing; and identifying unique identification of the detected ambient IWS source.

At 102, the wireless device learns the places that a user regularly goes and the routes that they take between them. This may be accomplished using existing and new approaches. For example, this may be accomplished by using the results of a periodic (e.g., approximately once per minute) WiFi scans. The places and routes are learned and later recognized based on the unique identifications of ambient IWS source observed during the periodic scans. The learning of routes and places may occur over the course of several days or weeks. More commonly visited places and travelled routes are learned more quickly while less commonly traveled routes take longer. New places and routes are added and old places and routes are pruned as the user's patterns change.

Operation 102 may also be described in this manner: The wireless device may be described as a route-recognizing wireless device. That device recognizes a route defined, at least in part, by ambient IWS sources encountered while a route-recognizing wireless device traverses along the route. The route recognition may involve the device learning the route based upon the device traversing the route. The route recognition may include accessing a database of already known or learned routes.

At 104, the wireless device maps a recognized route. That is, the device correlates recognized routes with determined locations. This phase occurs once route has been learned sufficiently well (in accordance with operation 102) and has been deemed a good candidate for route correlation. In this situation, the wireless device performs frequent WiFi scans (e.g., approximately once per second) and activates the GPS or some other location determination system. Once GPS has obtained a lock, the wireless device stores each subsequent WiFi scan result in association with the latest GPS location estimate.

Upon completion of the route, the resulting set of WiFi scans and corresponding GPS readings forms a WiFi fingerprint map that is associated with the just-traveled route. In short, the route may be described as a fingerprinted route. To improve accuracy, the mapping process may be performed multiple times.

Operation 104 may also be described in this manner: The wireless device may be called a route-mapping wireless device. That device encounters one or more ambient IWS sources while the route-mapping wireless device traverses, at least in part, the recognized route. The device determines a location of the route-mapping wireless device in concurrence with encountering sources. The location determination may be accomplished via a GPS. The route-mapping wireless device determines a signal fingerprint (e.g., WiFi fingerprint) about the route-mapping wireless device in concurrence with the location determination. The device then correlates the determined location with the determined signal fingerprint and stores them in fingerprint-location database.

At 106, the wireless device estimates locations based upon a fingerprinted route. When the wireless device recognizes that the user is traveling a route that has been fingerprinted, the device can produce accurate location estimates without the use of GPS. The location estimate may produce longitudinal and latitudinal components.

To accomplish this, the wireless device scans for nearby WiFi WAPs (which are examples of ambient IWS sources) and performs WiFi fingerprinting using the route's fingerprint database as the map. Since the recognized route has been densely fingerprinted in previous trips (as part of operation 104), scans anywhere along the route should find close matches in the database. The resulting accuracy is comparable to the underlying GPS that was used to create the fingerprint map.

The operation 106 may also be described in this manner: The wireless device may be called the location-estimation wireless device. That device encounters one or more ambient IWS sources while the route-mapping wireless device traverses, at least in part, the recognized route. The device determines one or more present signal fingerprints (e.g., WiFi fingerprint) about the location-estimation wireless device in concurrence with encountering sources. The location-estimation wireless device finds a location (e.g., latitude and longitude values) stored in the fingerprint-location database in association with stored one or more signal fingerprints. The stored one or more signal fingerprints correspond to (e.g., match) the just-determined one or more signal fingerprints. The device then estimates the present location of the location-estimation wireless device based, at least in part, on the found location.

With the process 100 described above, the recognized routes of a person are WiFi fingerprinted. Rather, than attempt a Herculean task of fingerprinting an entire city, county, state, or country, the wireless device utilizes a model that recognizes when a user is traveling to a common destination along a familiar route. Once a route has been traveled a sufficient number of times, a fingerprint map for that route is created by using frequent WiFi scans and GPS for ground-truth location.

Compared to conventional approaches of location determination, implementations of the described technology provide location estimates with any arbitrary scan rates. Regardless of the refresh scan rate, the location estimates are just as accurate at scan rates of once every ten seconds or once per minute since each scan is independently matched against a route's fingerprint map. Typically, GPS requires thirty seconds or more to reacquire a fix once disabled.

Compared to conventional approaches of location determination, implementations of the described technology do not require a network connection. While observations of ambient IWS sources are used to localize, the implementations does this solely based on the IDs and RSSIs (received signal strength indicator) returned by the scan of ambient IWS sources. The implementations match against a compact, locally stored fingerprint map.

Some implementations involve wireless devices helping each other. For example, one wireless device with GPS may help other devices without GPS to accurately localize. A device with GPS (like a smartphone) can collect route fingerprints can be shared with devices that does not have GPS (say, entry-level laptops). Variations in WiFi chipsets and antennas can be compensated for with a simple linear adjustment to the RSSIs in a fingerprint database.

### Example Scenarios of Route Learning

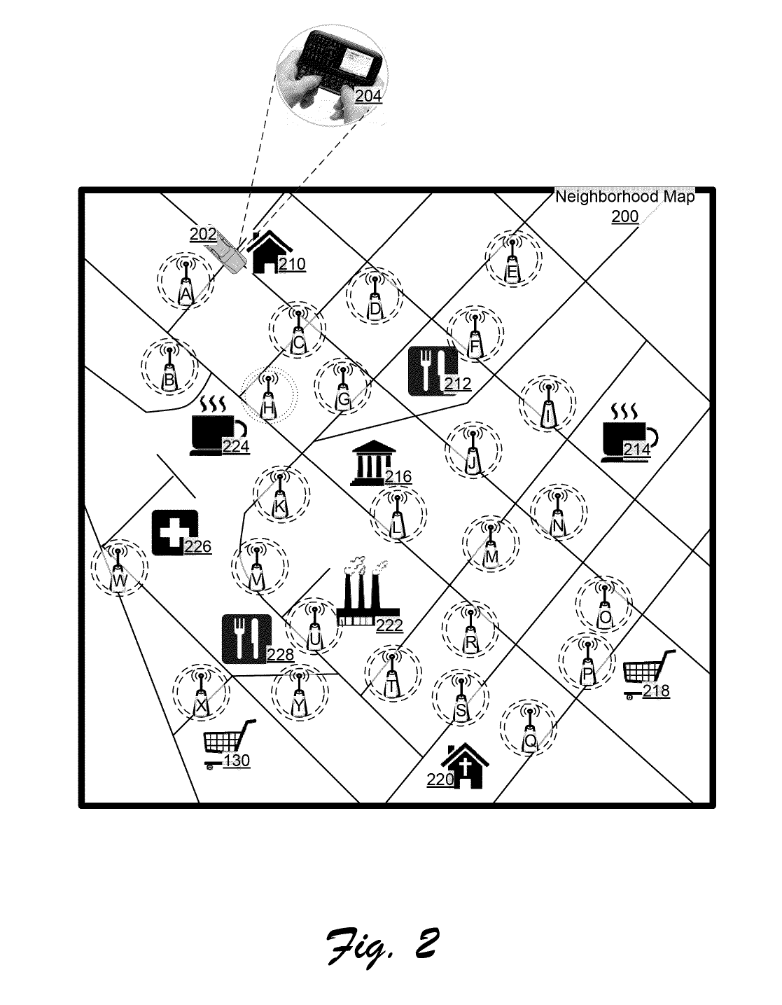

FIG. 2 includes an example neighborhood map 200 that will be used to illustrate example scenarios for route learning in which one or more implementations of the technology described herein may be employed. For illustration purpose, the map 200 shows an automobile 202 on a road that has a driver or passenger (not shown) with an active wireless device 204. While the wireless device 204 is active, a user does not need to interact with it. Indeed, if that user is the driver of the automobile, such action is generally unsafe. Indeed, with implementations described herein, the wireless device 204 may be programmed to automatically send messages at designated points along a route. For example, a text message may be automatically sent when the driver is five minutes away from his destination. This helps a driver avoid potentially dangerous distractions by manually inputting such a text message while driving.

The map 200 also shows several points of interest (POls), which may be known or determined start points or end points (i.e., destination) of a route traveled by user with the wireless device 204. The POls depicted in FIG. 2 include a home 210, a diner 212, a café 214 (i.e., coffee shop), a school 216, a grocery store 218, a church 220, a factory 222 (i.e., work), another café 224, a doctor's office 226, a restaurant 228, and a shopping center 230.

In addition, the map 200 shows many wireless access points (WAPs) distributed about the neighborhood. Each WAP is labeled with a capital letter ranging from A to Y. A dashed double-lined circle indicates the range of each depicted WAP. While not shown as such in map 200, each POI depicted in FIG. 2 also contains one or more WAPs.

The WAP is a specific example of an ambient identifiable wireless signal (IWS) source. The IWS sources are called ambient herein because they may be detected or “observed” in the environment while the wireless device 204 travels along a path on one or more of the streets, as shown on the map 200.

The IWS sources are called “identifiable” because each is uniquely identifiable. For example, each WAP may be uniquely identified by its basic service set identification (BSSID) or media access card (MAC) address. Of course, other identifying characteristics may be used alone or in combination with each other or with the BSSID or MAC address. Examples of such other identifying characteristics include service set identification (SSID) and received signal strength indication (RSSI).

In addition, once the IWS source is uniquely identified by a wireless device, an implementation may assign a unique identifier (ID) for convenience of handling. For example, the IWS source at a person's home may be labeled “Home,” as is shown at 210 in the map 200.

With at least one implementation, a list of ambient IWS sources is tracked when the wireless device 204 is active. Of course, when the user is stationary, the ambient IWS source does not change or at least varies little. However, when the user travels (with the wireless device 204) new IWS sources are noted along the travel path. For example, the user may be walking, running, in a motor vehicle, train, or some via some other sort of ground transport.

For example, with reference to map 200, presume that Dorothy spends eight hours at work 222. During the workday, the wireless device 204 records one or more IWS sources that have been or will be designated “Work.” After her workday, she drives to the shopping center 230 in her automobile 202. While traveling from work 222 to the store 218, her wireless device 204 encounters IWS sources labeled U, T, R, and P. After she takes this path many times, the pattern of Work, U, T, R, and P and Store will reoccur frequently. At that point, that pattern may be recognized route and identified. For convenience, that route is called Work→Store here. The naming convention follows the pattern of source, arrow, and then destination. The arrow indicates the directional nature of the routes. Of course, because other paths between work 222 and the store 218 exist, other routes may have the same label (Work→Store). For example, Work→Store may include Work, T, M, N, O, Store.

Instead of determining and tracking physical or geophysical locations like as are depicted on a map, the technology described herein tracks discrete places, which are the ambient IWSs encountered, and determines a route based, at least in part, upon an ordered pattern of such discrete places.

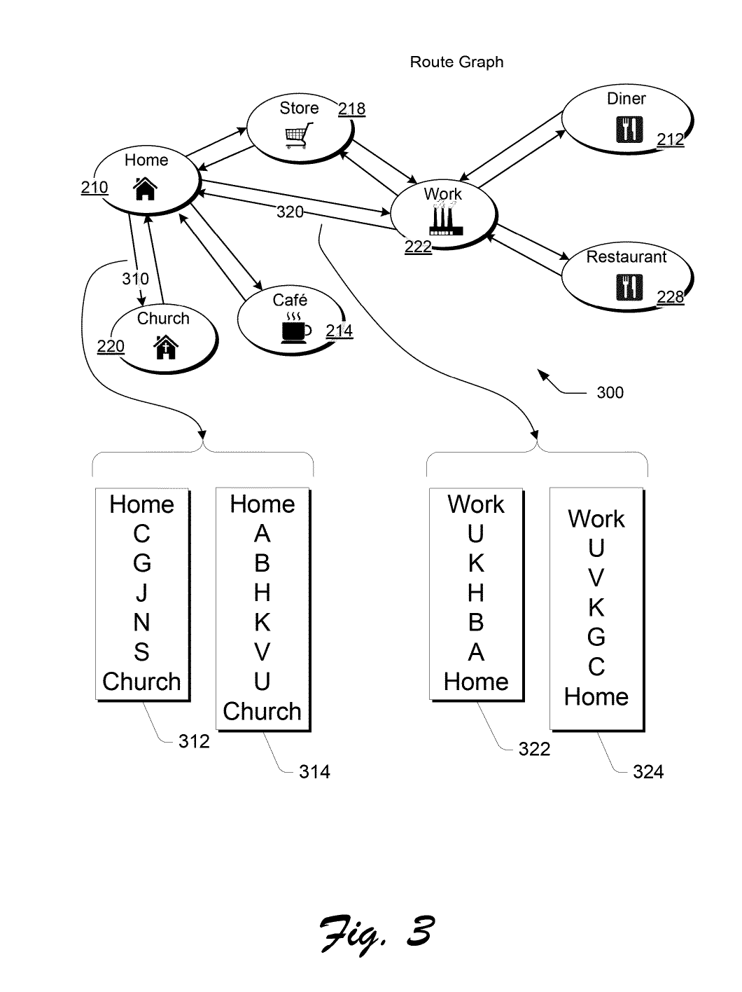

FIG. 3 shows a route graph 300, which is a logical depiction of some example routes that Dorothy has taken with her wireless device 204. Logically, Dorothy's places and routes can be viewed as a graph with connections between places that have been traveled between directly. The graph 300 includes example sources (i.e., start points) and destinations (i.e., end points) of the example routes. Those example sources/destinations are selected from those depicted in the map 200. The selected example sources/destinations include home 210, church 220, store 218, café 214, work 222, diner 212, and restaurant 228.

In the route graph 300, the arrows indicate the route and direction of the route between points. For Home→Church route 310, the wireless device 204 has, for example, recorded at least two different paths, as represented by route datasets 312 and 314, respectively. Route dataset 312 includes Home, C, G, J, N, S, and Church. Route dataset 314 includes Home, A, B, H, K, V, U, and Church. For Work→Home route 320, the wireless device has, for example, recorded at least two different paths, as represented by route datasets 322 and 324, respectively. Route dataset 322 includes Work, U, K, H, B, A, and Home. Route dataset 324 includes Work, U, V, K, G, C, and Home.

The depicted route datasets are one possible implementation. Other implementations, like those described herein, may be more complex. In those implementations, each given route (e.g., route of Work→Home) has one dataset that tracks all ambient IWS sources encountered each time trip from that start point to that destination is taken. In addition, other information (such as timing) may be tracked in the route dataset as well.

At any given time, Dorothy is either in a single place or is en route to a new place. Since routes overlap in the physical world and since routes pass near places she might stop, it is often not possible to predict Dorothy's state as a singular route or place. For example, when Dorothy drives out of work 222, she may be going home 210, to a café 224, or possibly to the school 216 to pick up the kids. Since all three places lay along the same path, it may be hard to determine which path you are on solely from the environment. Even a passenger in the automobile 202 with Dorothy is likely unable to determine her destination using the environment alone.

Therefore, the implementations described herein consider all of the three places as possible destinations. Further, consider that Dorothy may encounter a red traffic light on the same corner as the café 224. For the sixty seconds that Dorothy waits for the light to continue on home 210, implementations will take into consideration that Dorothy has, in fact, stopped for coffee. To accommodate this, the implementations predict the user's state as being in at most one single place (e.g., café 224) and/or traveling one of a set of possible routes. (e.g. {‘Work→Home’, ‘Worké Store, ‘Work→café’}).

The technology described herein may utilize any new or existing place-recognition technology that learns and recognizes when a user is visiting a particular place. For example, the technology may be linked to a workplace security system and note that the user is located at work 222 because she has scanned her identification badge to gain entry into the work buildings. Otherwise, via data entry, a user may simply identify a IWS source or a collection of such sources with a name, such as “work.”

### Example Route-Mapping Scenario

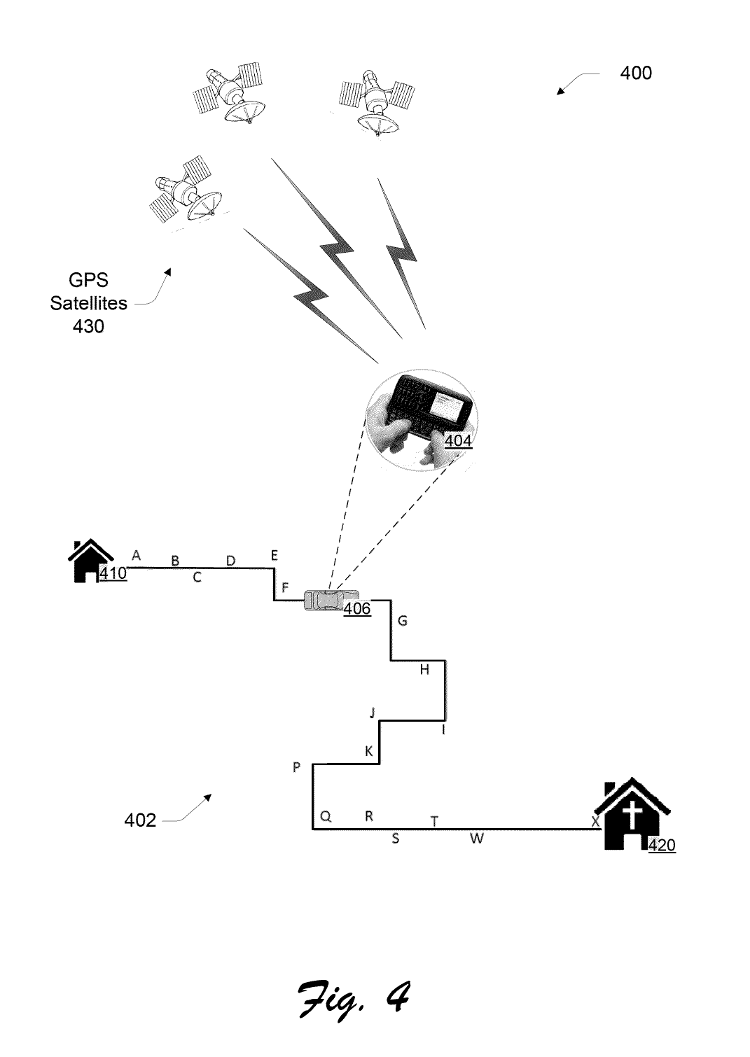

FIG. 4 illustrates a scenario 400 for route mapping in accordance with one or more implementations described herein. The scenario 400 includes a simplified example route traversal 402 that is traveled by a person with wireless device (such as wireless device 404) in an automobile 406. Of course, in other situations, the route may be traveled on foot, on bicycle, or other using other ground transportation. The example scenario 400 is provided to illustrate the operation of the route-mapping operation, such as is described herein for operation 104 of example process 100.

For the route-mapping operation, the wireless device 404 is linked to one or more GPS satellites 430. This link occurs while the device is traveling a recognized route and the route-mapping operation is being performed.

Consider an example situation where the user begins a journey at her home 410 in her automobile 406 and with her wireless device 404. She travels to a church 420. She takes this journey often. Along the way, the wireless device 404 may encounter the following ambient IWS sources as shown in FIG. 4: A, B, C, D, F, G, H, I, K, P, R, Q, T and X. In this example, the device missed a few sources, such as E, J, S, and W.

Along the way, the wireless device 404 determines that it is traveling a route that it recognizes. The device 404 determines whether recognized route is designated or deemed a good candidate for route mapping. This may be accomplished via user input and/or based upon frequency of repeated trips or the like.

If the route is both recognized and worthy for mapping, the wireless device 404 begins frequent WiFi scans (e.g., approximately once per second) and activates the GPS. Of course, other location determination technology may be employed. Once GPS has obtained a lock, the wireless device 404 stores each subsequent WiFi scan result in association with the latest GPS location determination.

In this example trip from Home 410 and Church 420, the wireless device determines the WiFi fingerprints based on the received signals from ambient IWS sources: Home, A, B, C, D, F, G, H, I, K, P, R, Q, T, X and Church. The wireless device 404 correlates the WiFi fingerprint of these ambient IWS sources to the locations determined by GPS.

Once the user reaches her destination (e.g., the Church 420), the wireless device 204 disables GPS and ends the mapping. The resulting set of WiFi scans and corresponding GPS readings forms a WiFi fingerprint map that is associated the just-traveled route between Home 410 and Church 420.

Multiple mappings may be performed to iteratively improve mapping. For example, on future trips along this route, the wireless device 404 may encounter and map the ambient IWS sources that it missed before, such as E, J, S, and W. The mapping operation (like the learning process) is iteratively updated and improved based upon changing conditions.

Although route-mapping function (e.g., operation 104 of FIG. 1) for creating the fingerprint map for a route is power-intensive (like the use of GPS itself), it need only be performed a small number of times (e.g., 1 to 3). Once the fingerprint map has been created for a route, operation 106 utilizes that map to do accurate WiFi-only location estimation along that route from then on.

### Example Location Estimation Scenario

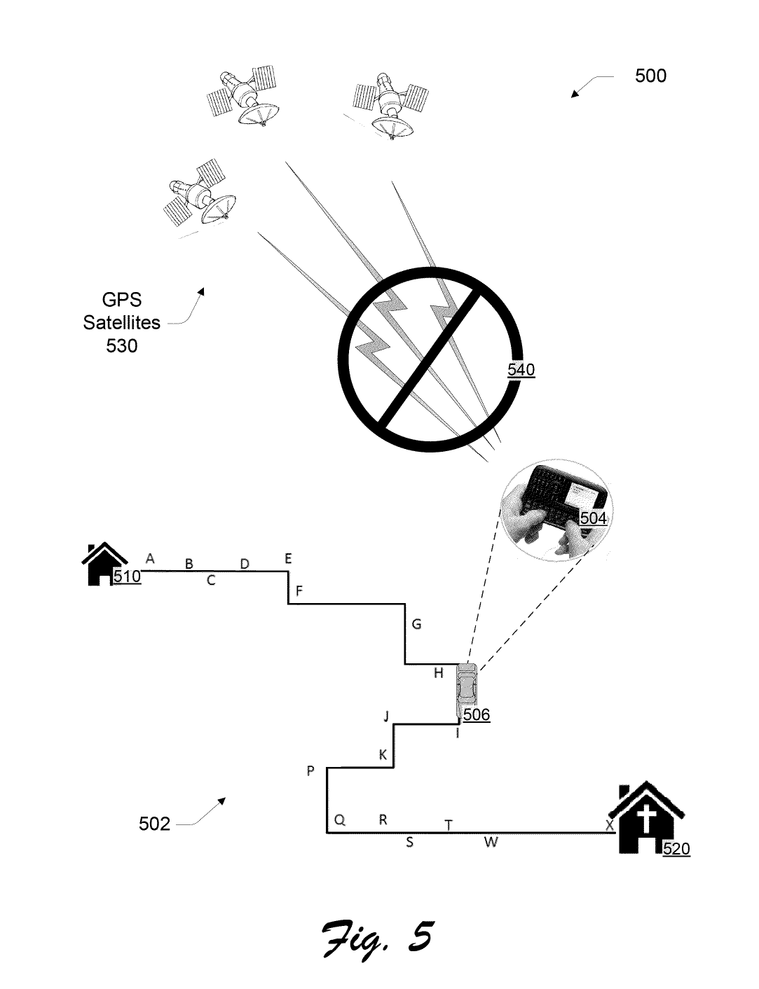

FIG. 5 illustrates a scenario 500 for location estimation in accordance with one or more implementations described herein. The scenario 500 includes a simplified example route traversal 502 that is traveled by a person with wireless device (such as wireless device 504) in an automobile 506. The example scenario 500 is provided to illustrate the operation of the route-mapping operation, such as is described herein for operation 104 of example process 100.

The user, route traversal 502, wireless device 504, Home 510, Church 520, and ambient IWS sources located en route therebetween of FIG. 5 may the same as the user, route traversal 402, wireless device 404, Home 410, Church 420, and ambient IWS sources located en route therebetween of FIG. 4. Alternatively, FIG. 5 may illustrate a different set of components than that illustrated in FIG. 4.

For the location estimation operation, the wireless device 504 is not linked to one or more GPS satellites 530. This is graphically illustrated by a circle-backslash symbol 540 in FIG. 5. Indeed, for the location estimation operation, the wireless device 504 does not need this link.

Consider an example situation where user begins a journey at her home 510 in her automobile 506 and with her wireless device 504. She travels to a church 520. Along the way, the wireless device 504 encounters the following ambient IWS sources as shown in FIG. 5: A, B, C, G, H, I, K, P, T and X. In this example, the device misses a few sources, such as D, F, E, J, S, R, Q, and W.

Along the way, the wireless device 504 determines that the route being traveled is both recognized and fingerprinted. If so, the device 504 produces accurate location estimates without the use of GPS. To accomplish this, the wireless device 504 scans for nearby WiFi WAPs (which are examples of ambient IWS sources) and perform WiFi fingerprinting using the route's fingerprint database as the map.

The fingerprint matching technique may do a pair-wise comparison between a live subject scan and stored scans in the database finding the fingerprint with the smallest Euclidian distance in signal space. Approaches that are more sophisticated may perform an average of the k closest fingerprints and perform outlier elimination to improve performance.

Once the fingerprint map has been created for a route, operation 106 utilizes that map to do accurate WiFi-only location estimation along that route from then on. During the journey, background applications and services of the wireless device 504 may utilize the location estimations along the way.

### Example System

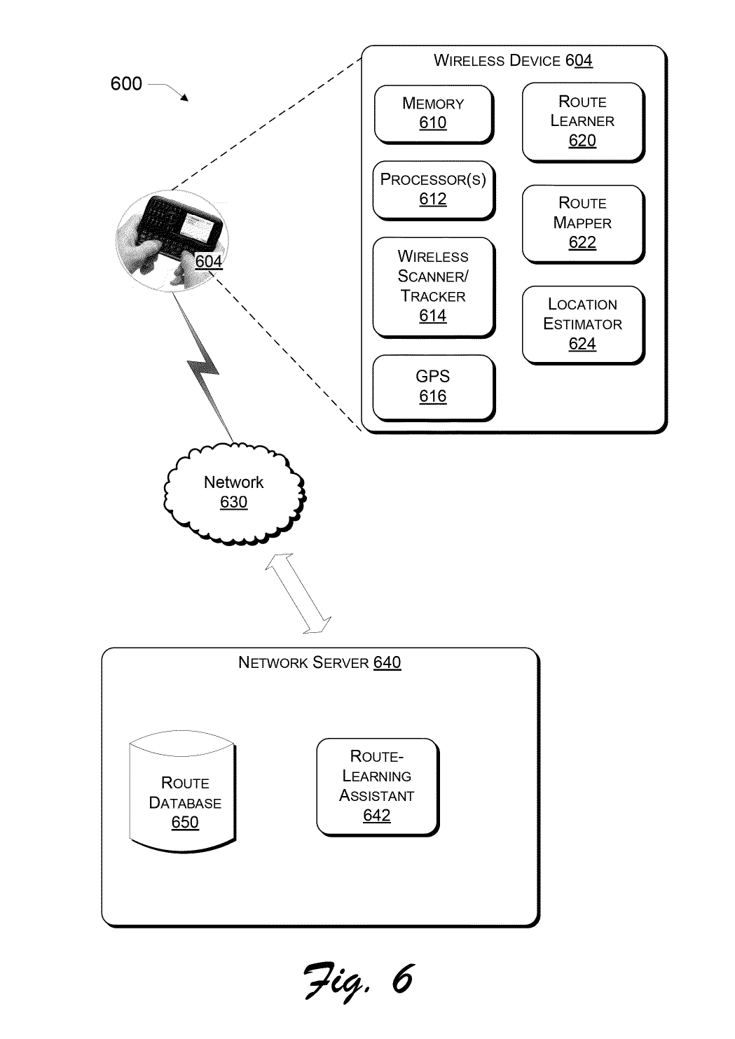

FIG. 6 illustrates example system 600 for implementing the technology described herein. The system 600 includes the wireless device 604, a network 630, and a network or cloud-based server 640. The wireless device 604 maybe the same as or similar to wireless devices 104, 104, 404, and 504, which have already been introduced herein.

The wireless device 504 includes a memory 610, one or more processor(s) 612, a wireless scanner/tracker 614, a GPS 616, a route learner 620, a route mapper 622, and a location estimator 624. These functional components may be separate or some combination of hardware units. Alternatively, the components may be implemented, at least in part, in software and thus be stored in the memory 610 and executed by the processors 612.

The memory 610 may include its own local route database (akin to the to-be-described route database 650). The local route database on the wireless device 604 stores the routes that have been learned by the device and the scanner/tracker 614 uses those route definitions in performing its tracking. The memory 610 may include a fingerprint-location database.

The wireless scanner/tracker 614 periodically scans for ambient IWS sources. The scanner/tracker 614 helps identify the encountered ambient IWS sources and store them in the memory 610. Using a stream of encountered ambient IWS sources, the route learner 620 finds reoccurring patterns and learns routes. The route mapper 622 generates a WiFi fingerprinted map of GPS determined locations. A portion of the route mapper 622 may be called the fingerprinter. The location estimator 624 estimates a location when the device 604 is traveling a recognized and fingerprinted route.

The network 630 may be a wired and/or wireless network. It may include the Internet infrastructure and it may be presented as the so-called “cloud.” The network 630 may include wired or wireless local area network, a cellular network, and/or the like. The network 630 links the wireless device 204 with the network server 640. Many implementations of the technology described here may operate independently of network assistance.

The network or cloud-based server 640 provides assistance to the wireless device 604 as part of one or more implementations of the technology described herein. In some implementations, the network 630 and network server 640 are not utilized. The network server 640 may be one or more actual servers.

The network server 640 includes a route-learning assistant 642 and a route database 650. The route-learning assistant 642 may help the route learner 620 learn routes. This may be accomplished by off-loading data processing and data-transfer to off-peak times. For example, the most recent tracking data may be uploaded at night for data processing and reporting overnight.

The route database 650 stores a collection of route datasets collected from the wireless device 604 and other networked wireless devices. This database may be consulted for cross-referencing ambient IWS sources and routes traveled by various wireless devices. All or part of the route database may be described as a route snippet database because it stores snippets of routes.

As depicted and discussed, the wireless devices 204, 404, 504, 604, and 604 are mobile phones. However, these devices may be some other type of portable devices, such as smartphones, cell phones, tablet computers, any wireless-enabled wearable devices, laptop computers, netbook computers, or the like.

### Example Computing Device

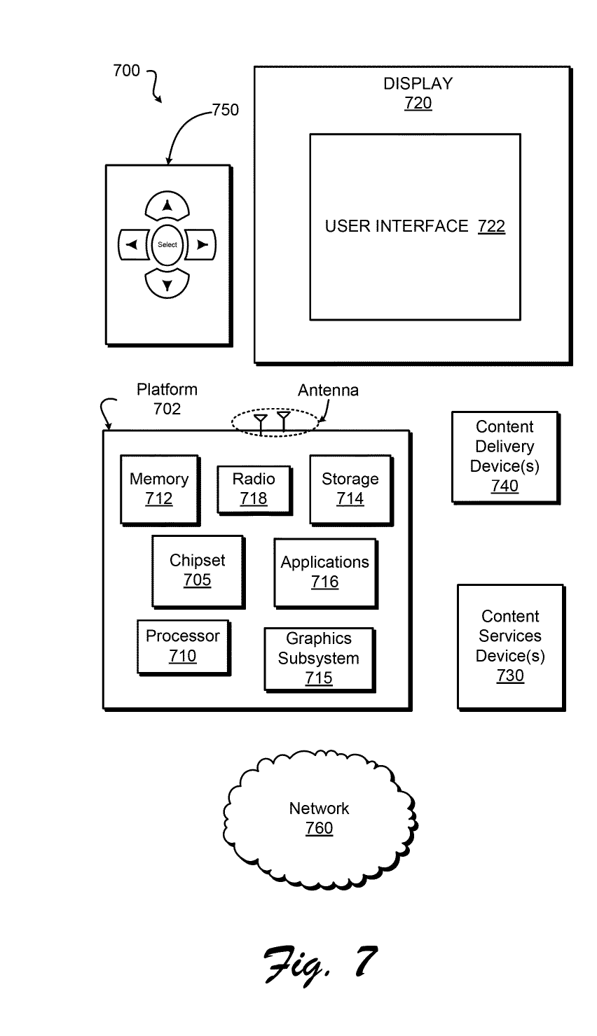

FIG. 7 illustrates an example system 700 that may implement, at least in part, the technologies described herein. In various implementations, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 700 includes a platform 702 coupled to a display 720. Platform 702 may receive content from a content device such as content services device(s) 730 or content delivery device(s) 740 or other similar content sources. A navigation controller 750 including one or more navigation features may be used to interact with, for example, platform 702 and/or display 720. Each of these components is described in detail below.

In various implementations, platform 702 may include any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as a Complex Instruction Set Computer (CISC) or Reduced Instruction Set Computer (RISC) processors, x86 instruction set compatible processors, multi-core, or any other microprocessor or central processing unit (CPU). In various implementations, processor 710 may be dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 714 may include technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, Display Port, wireless HDMI, and/or wireless HD compliant techniques. Graphics subsystem 715 may be integrated into processor 710 or chipset 705. In some implementations, graphics subsystem 715 may be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general-purpose processor, including a multi-core processor. In further embodiments, the functions may be implemented in a consumer electronics device.

Radio 718 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In various implementations, display 720 may include any television type monitor or display. Display 720 may include, for example, a computer display screen, touch screen display, video monitor, television-like device, and/or a television. Display 720 may be digital and/or analog. In various implementations, display 720 may be a holographic display. In addition, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In various implementations, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In various implementations, content services device(s) 730 may include a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be replicated on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but may be integrated into platform 702 and/or display 720. The present disclosure, however, is not limited to the elements or in the context shown or described herein.

In various implementations, drivers (not shown) may include technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 even when the platform is turned “off.” In addition, chipset 705 may include hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various implementations, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the present disclosure.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 7.

As described above, system 700 may be embodied in varying physical styles or form factors. FIG. 7 illustrates implementations of a small form factor device 700 in which system 700 may be embodied. In embodiments, for example, device 700 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

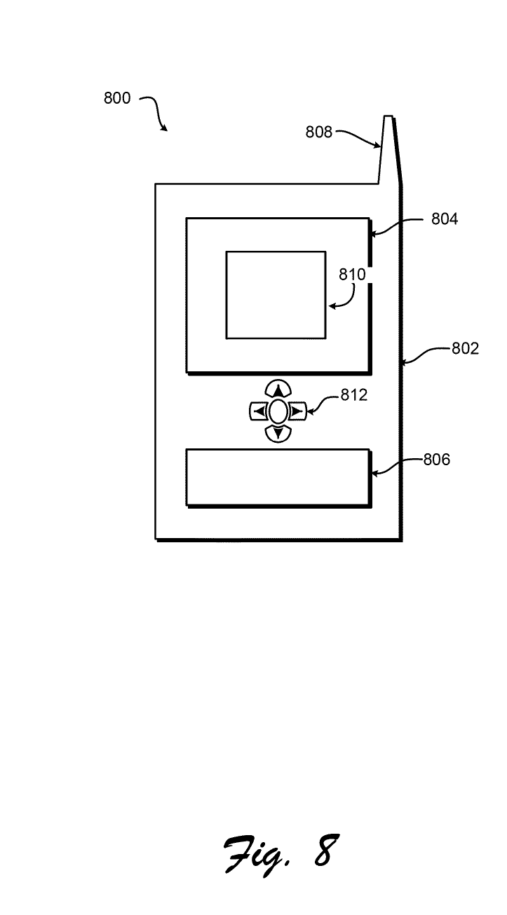

As shown in FIG. 8, device 800 may include a housing 802, a display 804, an input/output (I/O) device 806, and an antenna 808. Device 800 also may include navigation features 812. Display 804 may include any suitable display unit for displaying information appropriate for a mobile computing device. I/O device 806 may include any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone (not shown). Such information may be digitized by a voice recognition device (not shown). The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

### Additional and Alternative Implementation Notes

In the above description of exemplary implementations, for purposes of explanation, specific numbers, materials configurations, and other details are set forth in order to better explain the present invention, as claimed. However, it will be apparent to one skilled in the art that the claimed invention may be practiced using different details than the exemplary ones described herein. In other instances, well-known features are omitted or simplified to clarify the description of the exemplary implementations.

The inventor intends the described exemplary implementations to be primarily examples. The inventor does not intend these exemplary implementations to limit the scope of the appended claims. Rather, the inventor has contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “technology,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

In the claims appended herein, the inventor invokes 35 U.S.C. §112, paragraph 6 only when the words “means for” or “steps for” are used in the claim. If such words are not used in a claim, then the inventor does not intend for the claim to be construed to cover the corresponding structure, material, or acts described herein (and equivalents thereof) in accordance with 35 U.S.C. §112, paragraph 6.

1. A method comprising:
recognizing a route defined, at least in part, by ambient identifiable wireless signal (IWS) sources encountered while a route-recognizing wireless device traverses along the route;
generating a fingerprint-location database in which signal fingerprints based upon the ambient IWS sources is associated with one or more determined locations, the generating occurring while a route-mapping wireless device traverses at least part of the route;
estimating a present location of a location-estimation wireless device which traverses at least part of the route, wherein the location estimation is based upon the generated fingerprint-location database.

2. A method as recited by claim 1, wherein the route-recognizing wireless device, the route-mapping wireless device, and the location-estimation wireless device are the same device.

3. A method as recited by claim 1, wherein at least two of the route-recognizing wireless device, the route-mapping wireless device, and the location-estimation wireless device are the same device.

4. A method as recited by claim 1, wherein the recognizing includes learning the route based upon the route-recognizing wireless device traversing the route.

5. A method as recited by claim 1, the recognizing, generating, or estimating includes:
encountering an ambient IWS source while one of the wireless devices is traveling, wherein the encountering includes:
detecting the ambient IWS source while traversing;
identifying unique identification of the detected ambient IWS source.

6. A method as recited by claim 1, wherein the generating includes:
encountering one or more ambient IWS sources while the route-mapping wireless device traverses, at least in part, the recognized route;
determining a location of the route-mapping wireless device in concurrence with the encountering;
determining a signal fingerprint about the route-mapping wireless device in concurrence with the determining of the location, wherein the determined signal fingerprint is based at least in part upon the one or more ambient IWS sources encountered;
correlating the determined location with the determined signal fingerprint;
storing the correlated location and signal fingerprint in a database.

7. A method as recited by claim 1, wherein the signal fingerprints are WiFi fingerprints.

8. A method as recited by claim 1, wherein the generating includes determining a location of the route-mapping wireless device, the location being determined, at least in part, by a global positioning system (GPS).

9. A method as recited by claim 1, wherein the location estimating includes:
encountering one or more ambient IWS sources while the route-mapping wireless device traverses, at least in part, the recognized route;
determining one or more present signal fingerprints about the location-estimation wireless device in concurrence with the encountering;
finding a location stored in the fingerprint-location database in association with one or more stored signal fingerprints, wherein the one or more stored signal fingerprints correspond to the one or more present signal fingerprints;
estimating the present location of the location-estimation wireless device based, at least in part, the found location.

10. A method as recited by claim 1, wherein the location estimating lacks input from a global positioning system (GPS).

11. A method as recited by claim 1, wherein the estimated location is a geo-location.

12. A method of producing a fingerprint-location database, the method comprising:
encountering one or more ambient identifiable wireless signal (IWS) sources while a route-mapping wireless device traverses a route, wherein the encountering includes:
detecting the ambient IWS sources while traversing;
identifying unique identification of the detected ambient IWS sources;
determining a location of the route-mapping wireless device in concurrence with the encountering;
determining a signal fingerprint about the route-mapping wireless device in concurrence with the determining of the location, wherein the determined signal fingerprint is based at least in part upon the one or more ambient IWS sources encountered;
correlating the determined location with the determined signal fingerprint;
storing the correlated location and signal fingerprint in fingerprint-location database.

13. A method as recited by claim 12, wherein the signal fingerprints are WiFi fingerprints.

14. A method as recited by claim 12, wherein the location is determined, at least in part, by a global positioning system (GPS).

15. A method as recited by claim 12, wherein determined location is a geo-location.

16. A method of location estimation, the method comprising:
encountering one or more ambient identifiable wireless signal (IWS) sources while a location-estimation wireless device traverses a route, wherein the encountering includes:
detecting the ambient IWS sources while traversing;
identifying unique identification of the detected ambient IWS sources;
determining one or more present signal fingerprints about the location-estimation wireless device in concurrence with the encountering;
finding a location stored in the fingerprint-location database in association with one or more stored signal fingerprints, wherein the one or more stored signal fingerprints correspond to the one or more present signal fingerprints;
estimating the present location of the location-estimation wireless device based, at least in part, the found location.

17. A method as recited by claim 16, wherein the signal fingerprints are WiFi fingerprints.

18. A method as recited by claim 16, wherein determined location is a geo-location.

19. One or more computer-readable media with processor-executable instructions stored thereon which when executed by one or more processors cause performance of operations comprising:
encountering one or more ambient identifiable wireless signal (IWS) sources while a wireless device traverses a route;
determining a location of the wireless device in concurrence with the encountering;
determining a signal fingerprint about the wireless device in concurrence with the determining of the location, wherein the determined signal fingerprint is based at least in part upon one or more of the ambient IWS sources encountered;
correlating the determined location with the determined signal fingerprint;
estimating a present location of the wireless device while the wireless device is traversing, the estimating being based, at least in part, upon the determined correlated with the determined signal fingerprint.

20. One or more computer-readable media as recited by claim 19, wherein the signal fingerprints are WiFi fingerprints.

21. One or more computer-readable media as recited by claim 19, wherein determined location is a geo-location.

22. One or more computer-readable media as recited by claim 19, wherein the location is determined, at least in part, by a global positioning system (GPS).

23. One or more computer-readable media as recited by claim 19, wherein the estimating of the present location lacks input from a global positioning system (GPS).

24. A wireless device comprising:
a scanner configured to scan and encounter ambient identifiable wireless signal (IWS) sources while the wireless device is traveling along a route;
a fingerprint-location database configured to store a location in association with one or more signal fingerprints, wherein the one or more signal fingerprints are based, at least in part, upon ambient IWS sources encountered at a real-world location represented by the stored location;
fingerprinter configured to determine a signal fingerprint about the wireless device;
location estimator configured to estimate a location of the wireless device based, at least in part, upon a stored location in the fingerprint-location database, the stored location being associated with a signal fingerprint determined by the fingerprinter.

25. A wireless device as recited by claim 24, wherein the signal fingerprints are WiFi fingerprints.

26. A wireless device as recited by claim 24, wherein the estimated location is a geo-location.

27. A wireless device as recited by claim 24, wherein the stored location is determined, at least in part, by a global positioning system (GPS).

28. A wireless device as recited by claim 24, wherein the wireless device is selected from a group consisting of cellular phone, mobile phone, smartphone, tablet computer, netbook computer, portable computer, laptop computer, personal digital assistant (PDA), and mobile wireless device.
